(19) United States
(12) Patent Application Publication
(10) Pub. No.: US 2024/0038470 A1
(43) Pub. Date: Feb. 1, 2024

(54) CIRCUIT BREAKER AND POWER SUPPLY SYSTEM

(71) Applicant: Huawei Digital Power Technologies Co., Ltd., SHENZHEN (CN)

(72) Inventors: Ara BISSAL, Nuremberg (DE); Mario WALTER, Nuremberg (DE); Jingwen CHEN, Shenzhen (CN)

(21) Appl. No.: 18/374,794

(22) Filed: Sep. 29, 2023

Related U.S. Application Data
(63) Continuation of application No. PCT/CN2021/084026, filed on Mar. 30, 2021.

(51) Int. Cl. H01H 50/18; H01H 50/44; H01H 47/32

(52) U.S. Cl. CPC H01H 50/18; H01H 50/44; H01H 47/32

(57) ABSTRACT

A circuit breaker and a power supply system are disclosed. The circuit breaker includes a mechanical switch circuit, where the mechanical switch circuit includes a busbar, a power module, and a drive module. The power module includes a movable contact and a stationary contact, where the stationary contact is electrically connected to the busbar, the movable contact is movable, when the movable contact is in contact with the stationary contact, the mechanical switch circuit is conducted, and the drive module includes a movable coil and a stationary coil, where the movable coil and the stationary coil are placed adjacently, so that the movable coil and the stationary coil repel or attract each other based on whether current directions are the same, and the movable coil is configured to drive the movable contact to be in contact with or disconnected from the stationary contact.

### CROSS-REFERENCE TO RELATED APPLICATIONS

This application is a continuation of International Application No. PCT/CN2021/084026, filed on Mar. 30, 2021, the disclosure of which is hereby incorporated by reference in its entirety.

### TECHNICAL FIELD

This application relates to the electrical field, and in particular, to a circuit breaker and a power supply system.

### BACKGROUND

At present, power supply systems are widely used, and a circuit breaker is often used in this type of system to implement functions such as power distribution and protection. The circuit breaker may be applied to a direct current power supply system or an alternating current power supply system. Conventional circuit breakers include a mechanical circuit breaker and a solid-state circuit breaker, but both the mechanical circuit breaker and the solid-state circuit breaker have their own drawbacks. The mechanical circuit breaker needs many linkage apparatuses in a switching process, for example, a spring, a hook, a lever, and an armature, and linkage time is long. In addition, the mechanical circuit breaker uses a contact to implement circuit conduction and disconnection, and an electric arc is generated in a contact gap when the mechanical circuit breaker is opened, and arcing time is long. The electric arc is a cylindrical gas that emits strong light and conducts electricity and that is generated in the contact gap when the mechanical circuit breaker is opened. The circuit breaker is opened after the electric arc is extinguished and the contact gap becomes an insulation medium. The arcing time is a time period during which the electric arc is generated in each phase of the circuit breaker when the circuit breaker is opened. For the above reasons, the mechanical circuit breaker can only implement breaking time in milliseconds (ms), and a short-circuit breaking speed is slow. The solid-state circuit breaker uses a power electronic device instead of a switch to perform conduction and disconnection, and the solid-state circuit breaker can implement very fast switching time. However, due to a limitation of a current manufacturing process of an electronic power switch, a conduction loss of the solid-state circuit breaker is high, and a water-cooled heat sink is often used, which results in an increased volume and costs.

Therefore, the industry urgently needs a circuit breaker that can implement a faster short-circuit breaking speed, a lower conduction loss, and lower costs.

### SUMMARY

This application provides a circuit breaker and a power supply system, which can optimize switching performance of the circuit breaker.

According to a first aspect, a circuit breaker is provided. The circuit breaker includes a mechanical switch circuit, and the mechanical switch circuit includes a busbar; a power module, including a movable contact and a stationary contact, where the stationary contact is electrically connected to the busbar, the movable contact is movable, when the movable contact is in contact with the stationary contact, the mechanical switch circuit is conducted, and when the movable contact is disconnected from the stationary contact, the mechanical switch circuit is disconnected; and a drive module, including a movable coil and a stationary coil, where the movable coil and the stationary coil are placed adjacently, so that the movable coil and the stationary coil repel or attract each other based on whether current directions are the same, and the movable coil is configured to drive the movable contact to be in contact with or disconnected from the stationary contact.

In an embodiment, the circuit breaker includes the mechanical switch circuit, and the mechanical switch circuit controls the current directions in the movable coil and the stationary coil, so that the movable coil and the stationary coil can attract or repel each other, and the movable coil can drive the movable contact to be in contact with or disconnected from the stationary contact. Finally, conduction and disconnection of the mechanical switch circuit is implemented. The switching manner simplifies linkage apparatuses and optimizes switching performance of the circuit breaker. For example, switching time of the mechanical switch circuit can be reduced, thereby reducing switching time of the circuit breaker.

In an embodiment, the movable coil and the movable contact are a fixed connection structure, or a linkage structure is disposed between the movable coil and the movable contact.

In an embodiment, the movable coil and the movable contact are the fixed structure, or the linkage structure is disposed between the movable coil and the movable contact, so that when the movable coil moves, the movable contact can be driven to move together to implement conduction and disconnection of the mechanical switch circuit. The switching manner simplifies linkage apparatuses, and switching time of the mechanical switch circuit can be reduced, thereby reducing switching time of the circuit breaker.

In an embodiment, the circuit breaker further includes a solid-state switch circuit, where the solid-state switch circuit is connected in parallel to the mechanical switch circuit, when the circuit breaker is closed, the solid-state switch circuit is conducted prior to the mechanical switch circuit, and when the circuit breaker is opened, the mechanical switch circuit is disconnected prior to the solid-state switch circuit.

In an embodiment, the mechanical switch circuit is connected in parallel to the solid-state switch circuit, and the solid-state switch circuit can avoid an electric arc generated in the contact when the mechanical switch circuit is conducted or disconnected, thereby shortening arcing time, improving a switching speed of the circuit breaker, and prolonging a service life of the mechanical switch circuit.

In an embodiment, the movable coil is specifically configured to: when the currents flowing through the movable coil and the stationary coil are in the opposite direction, stay away from the stationary coil, and drive the movable contact to be disconnected from the stationary contact; and when the currents flowing through the movable coil and the stationary coil are in same directions, approach the stationary coil, and drive the movable contact to be in contact with the stationary contact.

In an embodiment, the busbar includes a first busbar and a second busbar, the stationary contact includes a first stationary contact and a second stationary contact, the first stationary contact is fastened on the first busbar, and the second stationary contact is fastened on the second busbar.

In an embodiment, a wound coil of the movable coil uses a first conductive material, a wound coil of the stationary coil uses a second conductive material, and a density of the first conductive material is less than a density of the second conductive material.

The wound coil of the movable coil may use the conductive material with low density, to reduce quality of the movable coil, and further reduce energy required when the movable coil moves, to save power of the mechanical switch circuit.

In an embodiment, the movable coil and the stationary coil are connected in series with each other.

In an embodiment, the movable coil is coaxial with the movable contact, and the movable coil can drive the movable contact to move up and down in an axial direction.

In an embodiment, a protrusion part is disposed on a first surface of the movable contact, and the first surface of the movable contact is configured to be in contact with the stationary contact.

The protrusion part can be disposed along the first surface of the movable contact, to ensure a reliable connection of the movable and stationary contacts, thereby improving switching sensitivity of the circuit breaker.

In an embodiment, the movable coil and the movable contact are connected by using an insulation material.

According to a second aspect, a power supply system is provided. The power supply system includes the circuit breaker according to the first aspect or any possible implementation of the first aspect.

### BRIEF DESCRIPTION OF DRAWINGS

FIG. 1 is a schematic diagram of a circuit breaker 100 according to an embodiment of this application;

FIG. 2 is a schematic diagram of a working state of a mechanical switch circuit 20 according to an embodiment of this application;

FIG. 3 is a schematic diagram of a working state of a mechanical switch circuit 20 according to an embodiment of this application;

FIG. 4 is a schematic diagram of a circuit breaker 100 according to another embodiment of this application;

FIG. 5 is a schematic diagram of a structure of a solid-state switch circuit 60 according to an embodiment of this application;

FIG. 6 and FIG. 7 are respectively schematic diagrams of conduction of a solid-state switch circuit 60 in different current directions;

FIG. 8 is a three-dimensional schematic diagram of a sectional view of a mechanical switch circuit 20 according to an embodiment of this application;

FIG. 9 is a schematic diagram of a cross section of a mechanical switch circuit 20 in a conducting state according to an embodiment of this application;

FIG. 10 is a schematic diagram of a cross section of a mechanical switch circuit 20 in a conducting state according to an embodiment of this application;

FIG. 11 is a top view of a movable coil 210 according to an embodiment of this application; and

FIG. 12 is a schematic diagram of structures of a movable contact 211 and a stationary contact 222 according to an embodiment of this application.

### DESCRIPTION OF EMBODIMENTS

The following describes technical solutions of this application with reference to accompanying drawings.

For ease of understanding, several terms used in this application are first described.

Circuit breaker: can be applied to a direct current power supply system or an alternating current power supply system, and is a switch apparatus that can conduct, carry, and disconnect a current under a normal loop condition and can conduct, carry, and disconnect a current under an abnormal loop condition within specified time. The circuit breaker has overload, short-circuit, and undervoltage protection functions, and has a capability to protect a line and a power supply.

Solid-state circuit breaker: is also known as a solid-state switch circuit. The solid-state circuit breaker can be a circuit breaker using a transistor as a switching element, which implements control of the circuit breaker by a non-contact switch. A switch module mainly includes power electronic devices, which are opened and closed to complete conduction and disconnection control on a current in a normal loop.

Mechanical circuit breaker: is also known as a mechanical switch circuit and is a circuit breaker that uses a mechanical linkage apparatus to implement a switching function. The mechanical circuit breaker usually includes a contact system, an arc-extinguishing system, an operating mechanism, a trip unit, and the like.

Short-circuit breaking capability: refers to a maximum current value that a circuit breaker can break without being damaged.

An insulated gate bipolar transistor (IGBT) is a composite full-controlled voltage driven power semiconductor device that includes a bipolar junction transistor (BJT) and a metal-oxide-semiconductor field-effect transistor (MOSFET), and has advantages of a high input impedance of the MOSFET and a low conduction voltage drop of the BJT.

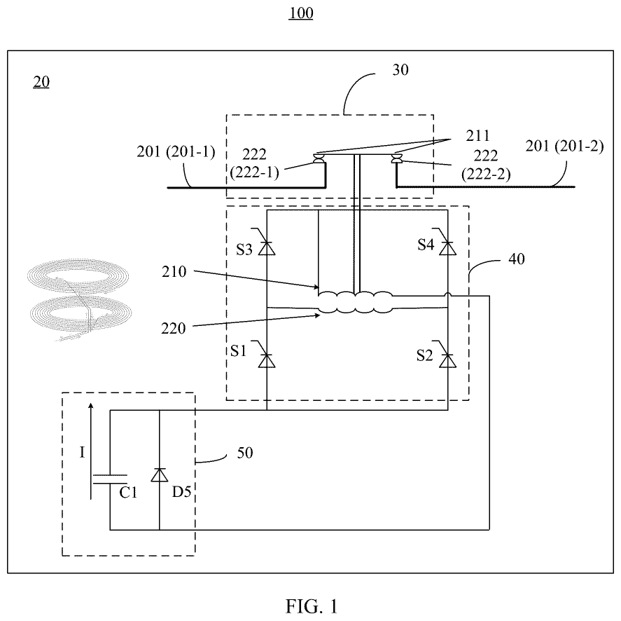

FIG. 1 is a schematic diagram of a circuit breaker 100 according to an embodiment of this application. As shown in FIG. 1, the circuit breaker 100 includes a mechanical switch circuit 20.

The mechanical switch circuit 20 includes a busbar 201, a power module 30, and a drive module 40. The busbar 201 is also referred to as a bus bank, is a main power supply line in a power device, has a large current flow capability, and usually includes a copper bar or an aluminum bar.

The power module 30 includes a movable contact 211 and a stationary contact 222, the stationary contact 222 is electrically connected to the busbar 201, and the movable contact 211 is movable. When the movable contact 211 is in contact with the stationary contact 222, the mechanical switch circuit 20 is conducted, and when the movable contact 211 is disconnected from the stationary contact 222, the mechanical switch circuit 20 is disconnected. In an embodiment, the movable contact 211 and the stationary contact 222 may alternatively be collectively referred to as a movable contact system.

In an embodiment, the busbar 201 may include a first busbar 201-1 and a second busbar 201-2, and the stationary contact 222 includes a first stationary contact 222-1 and a second stationary contact 222-2. The first stationary contact 222-1 is connected to the first busbar 201-1, and the second stationary contact 222-2 is connected to the second busbar 201-2. The first stationary contact 222-1 and the second stationary contact 222-2 are in an electrically disconnected state. Therefore, when the stationary contact 222 is disconnected from the movable contact 211, the first busbar 201-1 and the second busbar 201-2 are in a disconnected state, that is, the mechanical switch circuit 20 is in a disconnected state. When the stationary contact 222 is in contact with the movable contact 211, the movable contact 211 connects the first stationary contact 222-1 and the second stationary contact 222-2 to provide a low-resistance path between the first busbar 201-1 and the second busbar 201-2, so that the first busbar 201-1 is electrically connected to the second busbar 201-2, that is, the mechanical switch circuit 20 is in a conducting state.

In some examples, the stationary contact 222 and the busbar 201 are of an integrated structure, or the stationary contact 222 is a part of the busbar 201.

The drive module 40 includes a switch circuit, a movable coil 210, and a stationary coil 220. The movable coil 210 and the stationary coil 220 are placed adjacently, the switch circuit is configured to control current directions of the movable coil 210 and the stationary coil 220, and the movable coil 210 and the stationary coil 220 attract or repel each other based on whether the current directions are the same, so that the movable coil 210 drives the movable contact 211 to be in contact with or disconnected from the stationary contact 222.

The movable coil 210 is designed to drive the movable contact 211 to move. For example, the movable contact 211 and the movable coil 210 are a fixed connection structure, or a linkage structure is disposed between the movable contact 211 and the movable coil 210.

A specific connection manner between the movable contact 211 and the movable coil 210 is not limited in this embodiment of this application, provided that the movable coil 210 can drive the movable contact 211 to move when moving.

In an embodiment, the movable contact 211 and the movable coil 210 may be connected by using an insulation material, that is, the movable contact 211 and the movable coil 210 are electrically insulated. For example, the insulation material may include epoxy resin.

In other words, the switch circuit may control the current directions of the movable coil 210 and the stationary coil 220 to be the same or opposite.

In an embodiment, a specific placement manner of the movable coil 210 and the stationary coil 220 is not limited in this embodiment of this application, provided that a distance between the movable coil 210 and the stationary coil 220 can enable the movable coil 210 and the stationary coil 220 to repel or attract each other.

In some examples, if the movable coil 210 and the stationary coil 220 are placed side by side, and when the currents flowing through the movable coil 210 and the stationary coil 220 are in the opposite direction, the movable coil 210 stays away from the stationary coil 220, and drives the movable contact 211 to be disconnected from the stationary contact 222; and when the currents flowing through the movable coil 210 and the stationary coil 220 are in the same directions, the movable coil 210 approaches the stationary coil 220, and drives the movable contact 211 to be in contact with the stationary contact 222.

It should be understood that when the current directions between two coils are the opposite, directions of magnetic fields generated between the two coils are opposite. Therefore, the coils attract each other. When the current directions between the two coils are same, directions of magnetic fields generated between the two coils are the same. Therefore, the coils repel each other.

It may be understood that the switch circuit, the movable coil 210, and the stationary coil 220 form a drive system, and the movable coil 210, the movable contact 211, and the stationary contact 222 further form an armature system. In this application, an electromagnetic principle is used, so that the movable coil 210 drives the movable contact system to implement contact and disconnection, and switching time of the mechanical switch circuit 20 can be reduced.

It should be understood that the switching time of the mechanical switch circuit 20 is related to the distance between the movable coil 210 and the stationary coil 220. The disconnection of the mechanical switch circuit 20 is used as an example. A shorter distance between the movable coil 210 and the stationary coil 220 indicates a faster speed at which the movable contact 211 is separated from the stationary contact 222, a shorter delay time for the drive module 40 to start separation from the contact, and further, shorter switching time of the mechanical switch circuit 20. The distance between the movable coil 210 and the stationary coil 220 is adjusted, so that modulation of the switching time of the mechanical switch circuit 20 can be implemented.

The mechanical switch circuit 20 uses the electromagnetic principle, so that the movable coil 210 drives the movable contact 211 to be in contact with or disconnected from the stationary contact 222. The switching manner simplifies linkage apparatuses in a conventional mechanical switch circuit, and can optimize switching performance of the mechanical switch circuit 20. For example, the switching time of the mechanical switch circuit 20 can be reduced, thereby reducing switching time of the circuit breaker 100.

Still refer to FIG. 1. The switch circuit may include a plurality of switches (S1 to S4), and the current directions of the movable coil 210 and the stationary coil 220 are controlled by controlling turn-on and turn-off among the plurality of switches.

In some examples, the plurality of switches may be controllable switches. Specifically, the controllable switch may include a full-controlled switch or a semi-controlled switch. The full-controlled switch is also referred to as a self-turn-off device, which is a power electronic device that can control both turn-on and turn-off of the power electronic device by using a control signal. The full-controlled switch includes, but is not limited to, a gate turn-off thyristor (GTO), an MOSFET, and an IGBT.

The semi-controlled switch is a power electronic device that can only control turn-on of the power electronic device, but cannot control turn-off of the power electronic device by using a control signal. The semi-controlled switch includes but is not limited to the following: a thyristor.

For example, the switch circuit in FIG. 1 includes a first switch S1 to a fourth switch S4. A first end of the drive module 40 is connected to a first end of the first switch S1 and a first end of the second switch S2, a second end of the first switch S1 is connected to a first end of the stationary coil 220, a second end of the second switch S2 is connected to a second end of the stationary coil 220, a first end of the third switch S3 is connected to the first end of the stationary coil 220, a second end of the third switch S3 is connected to a first end of the movable coil 210, a first end of the fourth switch S4 is connected to the second end of the stationary coil 220, a second end of the fourth switch S4 is connected to the first end of the movable coil 210, and a second end of the movable coil 210 is connected to a second end of the drive module 40.

In FIG. 1, the movable coil 210 and the stationary coil 220 are connected in series with each other during working and are placed side by side.

It should be understood that the switch circuit in FIG. 1 is merely used as an example, and the switch circuit in this application may alternatively be implemented in another manner, provided that the switch circuit has a function of controlling the current direction of the movable coil 210 and the current direction of the stationary coil 220.

It should be understood that the circuit breaker 100 in FIG. 1 is merely used as an example. After proper deformation, the circuit breaker 100 may further include more or fewer functional modules and circuit components.

It should be understood that a connection between two components in this embodiment of this application may mean a direct connection, or may mean an indirect connection. In the case of the indirect connection, another unit, module, or component may be disposed between the two components.

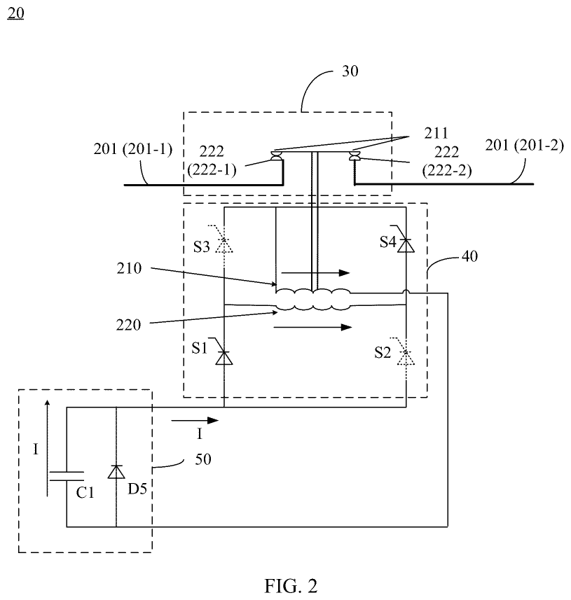

FIG. 2 is a schematic diagram of a working state of a mechanical switch circuit 20 according to an embodiment of this application. The movable coil 210 and the stationary coil 220 in FIG. 2 attract each other. As shown in FIG. 2, when the mechanical switch circuit 20 needs to be conducted, the first switch S1 and the fourth switch S4 may be controlled to be turned on, and the second switch S2 and the third switch S3 may be controlled to be turned off. A current sequentially flows through the first switch S1, the stationary coil 220, the fourth switch S4, and the movable coil 210. The current directions of the movable coil 210 and the stationary coil 220 are the same. Therefore, the movable coil 210 and the stationary coil 220 attract each other, and the movable coil 210 drives the movable contact to be in contact with the stationary contact.

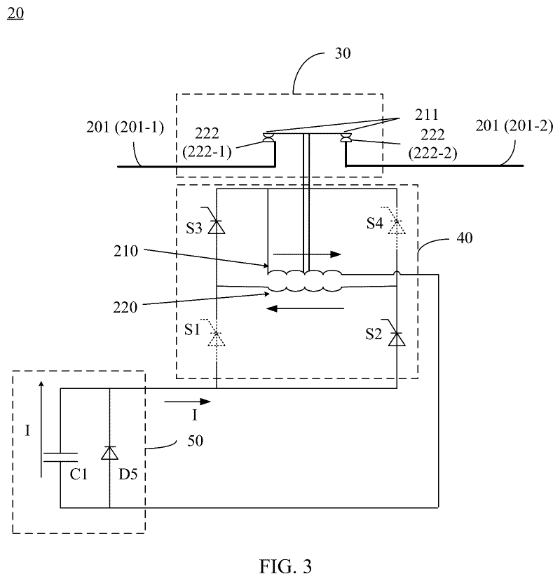

FIG. 3 is a schematic diagram of a working state of a mechanical switch circuit 20 according to an embodiment of this application. The movable coil 210 and the stationary coil 220 in FIG. 3 repel each other. As shown in FIG. 3, when the mechanical switch circuit 20 needs to be disconnected, the second switch S2 and the third switch S3 may be controlled to be turned on, and the first switch S1 and the fourth switch S4 may be controlled to be turned off. A current sequentially flows through the second switch S2, the stationary coil 220, the third switch S3, and the movable coil 210. The current directions of the movable coil 210 and the stationary coil 220 are opposite. Therefore, the movable coil 210 and the stationary coil 220 repel each other, and the movable coil 210 drives the movable contact to be disconnected from the stationary contact.

In an embodiment, turn-on and turn-off of the switch in the switch circuit may be controlled by a control module. The control module may be disposed in the mechanical switch circuit 20, or may be independent of the mechanical switch circuit 20. This is not limited in this embodiment of this application.

In an embodiment, as shown in FIG. 1, the mechanical switch circuit 20 further includes an energy storage module 50. The energy storage module 50 is configured to provide a current for the drive module 40, or provide, for the drive module 40, a current that flows through the movable coil 210 and the stationary coil 220.

In some examples, the energy storage module 50 may include a capacitor C1, and the capacitor C1 is configured to store an electric charge and provide a current. For example, the capacitor C1 may obtain power from the busbar 201 and store the electric charge. Alternatively, the capacitor C1 may obtain power in another manner, for example, obtain power from a battery. This is not limited in this application. The capacitor C1 may provide a transient-state large current, to implement fast conduction and disconnection of the mechanical switch circuit 20.

In an embodiment, a first end of the capacitor C1 is configured to connect to a first end of the drive module 40, and a second end of the capacitor C1 is configured to connect to a second end of the drive module 40.

In an embodiment, the capacitor C1 may be an electrolytic capacitor or a thin film capacitor, or may be a capacitor of another type.

Further, the energy storage module 50 further includes a diode D5, and the diode D5 and the capacitor C1 are in a parallel connection relationship. An anode of the diode D5 is connected to the second end of the capacitor C1, and a cathode of the diode D5 is connected to the first end of the capacitor C1. The diode D5 connected in parallel at two ends of C1 can improve discharge efficiency of C1, thereby increasing a switching speed of the mechanical switch circuit 20.

In an embodiment, the energy storage module 50 may alternatively use another implementation, provided that the energy storage module 50 can implement a function of providing the current for the movable coil 210 and the stationary coil 220. For example, the energy storage module 50 may also include a battery, and the current is provided by using the battery. Alternatively, the energy storage module 50 may further include a boost converter or a buck converter, to perform level conversion on a received voltage, and then output the current to the movable coil 210 and the stationary coil 220.

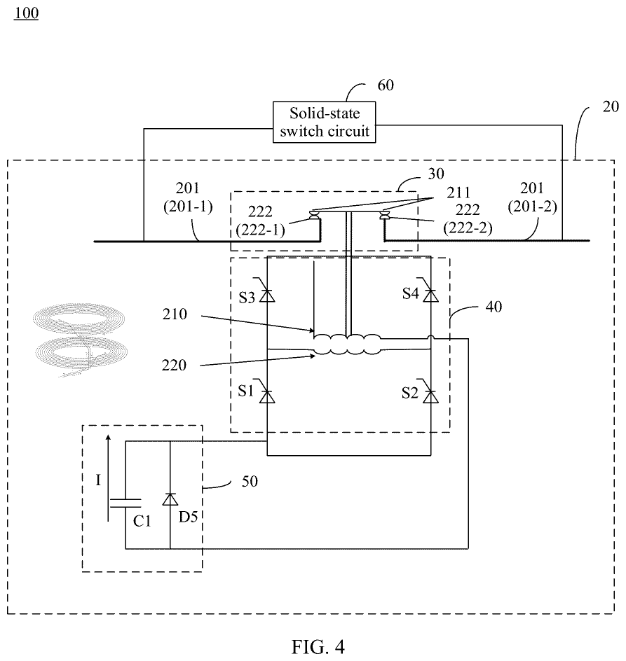

FIG. 4 is a schematic diagram of a circuit breaker 100 according to another embodiment of this application. In an embodiment, as shown in FIG. 4, the circuit breaker 100 may further include a solid-state switch circuit 60, and the solid-state switch circuit 60 and the mechanical switch circuit 20 are connected in parallel with each other. When the circuit breaker 100 is turned on, the solid-state switch circuit 60 is conducted prior to the mechanical switch circuit 20, and when the solid-state switch circuit 60 is disconnected, the mechanical switch circuit 20 is disconnected prior to the solid-state switch circuit 60.

In this embodiment of this application, the circuit breaker 100 uses a form in which the mechanical switch circuit 20 is connected in parallel to the solid-state switch circuit 60, and the solid-state switch circuit 60 can avoid an electric arc generated in the contact when the mechanical switch circuit 20 is conducted or disconnected, thereby shortening arcing time, improving a switching speed of the circuit breaker 100, and prolonging a service life of the mechanical switch circuit 20.

In an embodiment, a specific structure of the solid-state switch circuit 60 is not limited in this embodiment of this application, provided that the solid-state switch circuit 60 can implement a function of the solid-state switch circuit 60. For example, a specific example of the solid-state switch circuit 60 is described below with reference to FIG. 5 to FIG. 7.

FIG. 5 is a schematic diagram of a structure of a solid-state switch circuit 60 according to an embodiment of this application. As shown in FIG. 5, the solid-state switch circuit 60 includes a main switch circuit 61, a snubber circuit 62, and a buffer circuit 63.

The main switch circuit 61 includes diodes D1 to D4, and a switching transistor K1. The switching transistor K1 may be an IGBT, an integrated gate-commutated thyristor (IGCT), an MOS, or a BJT, or may be switching component of another type.

As shown in FIG. 5, a first end of the solid-state switch circuit 60 is connected to an anode of the diode D1 and a cathode of the diode D2, and a second end of the solid-state switch circuit 60 is connected to an anode of the diode D3 and a cathode of the diode D4. A cathode of the diode D1 and a cathode of the diode D3 are connected to a first end of the switching transistor K1, and an anode of the diode D2 and an anode of the diode D4 are connected to a second end of the switching transistor K1.

If the switching transistor K1 is the IGBT, the first end of the switching transistor K1 is a collector of the IGBT, and the second end of the switching transistor K1 is an emitter of the IGBT.

The main switch circuit 61 is configured to control the solid-state switch circuit 60 by controlling turn-on and turn-off of the switching transistor K1, and the main switch circuit 61 can implement a bidirectional control function.

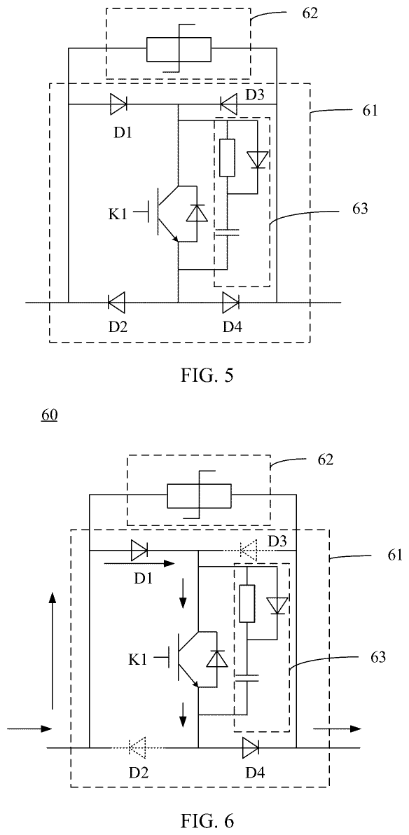

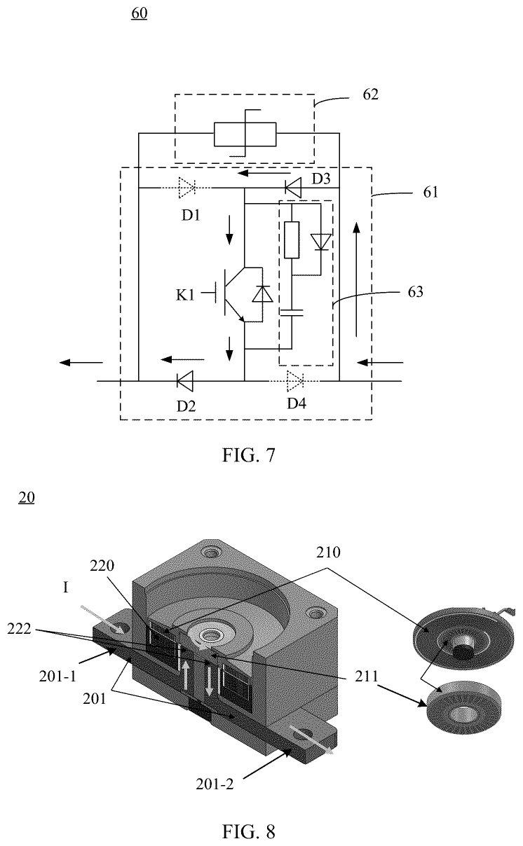

FIG. 6 and FIG. 7 are respectively schematic diagrams of conduction of a solid-state switch circuit 60 in different current directions. As shown in FIG. 6, the diode D1, the switching transistor K1, and the diode D4 may implement a current path in one direction. As shown in FIG. 7, the diode D3, the switching transistor K1, and the diode D4 may implement a current path in another direction.

The snubber circuit 62 may be configured to absorb energy when the switching transistor K1 is turned off. The snubber circuit 62 typically includes a varistor. The varistor can be connected in parallel in the circuit. When the circuit is in normal use, an impedance of the varistor is very high and a leakage current is very small, which can be regarded as an open circuit and has little impact on the circuit. However, when a very high suddenly changed voltage arrives, a resistance value of the varistor drops instantly, allowing a large current to flow through the varistor and clamp the overvoltage to a specific value.

The buffer circuit 63 is configured to protect the switching transistor K1 from being damaged due to the overvoltage when the switching transistor K1 is turned off, and reduce a turn-off loss of the switching transistor K1. A specific structure of the buffer circuit 63 is not limited in this application, provided that the buffer circuit 63 can implement the foregoing functions. In an embodiment, the solid-state switch circuit 60 may not include the buffer circuit 63.

The following describes a structure of the mechanical switch circuit 20 in embodiments of this application with reference to the accompanying drawings. FIG. 8 is a three-dimensional schematic diagram of a sectional view of a mechanical switch circuit 20 according to an embodiment of this application. As shown in FIG. 8, the mechanical switch circuit 20 includes a busbar 201, a power module (not marked in the figure), and a drive module (not marked in the figure).

The power module includes a movable contact 211 and a stationary contact 222. The stationary contact 222 is electrically connected to the busbar 201, the movable contact 211 is movable, when the movable contact 211 is in contact with the stationary contact 222, the mechanical switch circuit 20 is conducted, and when the movable contact 211 is disconnected from the stationary contact 222, the mechanical switch circuit 20 is disconnected.

The drive module includes a movable coil 210 and a stationary coil 220. The movable coil 210 and the stationary coil 220 are placed adjacently, so that the movable coil 210 and the stationary coil 220 repel or attract each other based on whether current directions are the same, and the movable coil 210 is configured to drive the movable contact 211 to be in contact with or disconnected from the stationary contact 222.

The movable coil 210 is designed to drive the movable contact 211 to move. For example, the movable contact 211 and the movable coil 210 are a fixed connection structure, or a linkage structure is disposed between the movable contact 211 and the movable coil 210.

A specific connection manner between the movable contact 211 and the movable coil 210 is not limited in this embodiment of this application, provided that the movable coil 210 can drive the movable contact 211 to move when moving.

In an embodiment, the movable contact 211 and the movable coil 210 may be connected by using an insulation material, that is, the movable contact 211 and the movable coil 210 are electrically insulated. For example, the insulation material may include epoxy resin.

It can be learned from FIG. 8 that, the busbar 201 includes two parts that are not connected to each other, which may be respectively referred to as a first busbar 201-1 and a second busbar 201-2, and the stationary contact 222 includes a first stationary contact 222-1 and a second stationary contact 222-2 (refer to FIG. 12). The first stationary contact 222-1 is connected to the first busbar 201-1, and the second stationary contact 222-2 is connected to the second busbar 201-2. The first stationary contact 222-1 and the second stationary contact 222-2 are in an electrically disconnected state. Therefore, when the stationary contact 222 is disconnected from the movable contact 211, the first busbar 201-1 and the second busbar 201-2 are in an electrically disconnected state, that is, the mechanical switch circuit 20 is in a disconnected state. When the stationary contact 222 is in contact with the movable contact 211, the movable contact 211 connects the first stationary contact 222-1 and the second stationary contact 222-2 to provide a low-resistance path between the first busbar 201-1 and the second busbar 201-2, so that the first busbar 201-1 is electrically connected to the second busbar 201-2, that is, the mechanical switch circuit 20 is in a conducting state.

As shown in FIG. 8, in some examples, the movable coil 210 is coaxial with the movable contact 211, and the movable coil 210 can drive the movable contact 211 to move up and down in an axial direction. Further, the stationary coil 220 is coaxial with the movable coil 210.

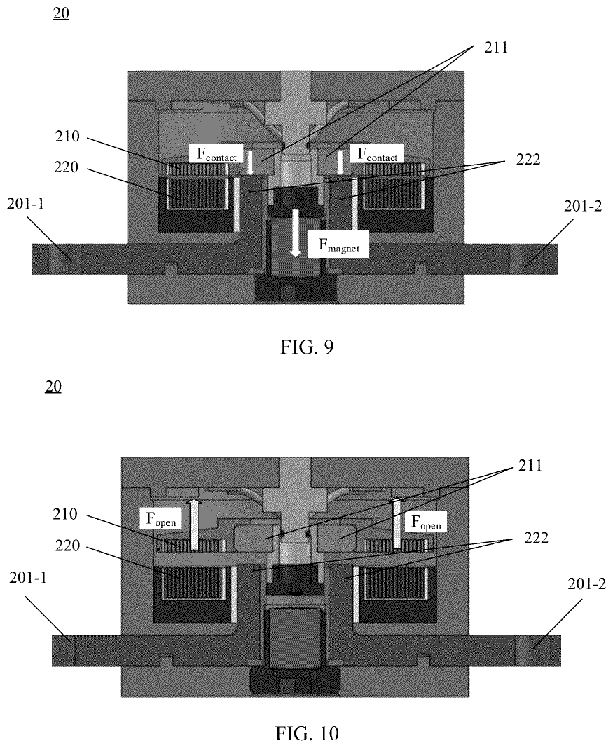

FIG. 9 is a schematic diagram of a cross section of a mechanical switch circuit 20 in a conducting state according to an embodiment of this application. As shown in FIG. 9, the movable coil 210 and the stationary coil 220 approach each other and are placed side by side. When the mechanical switch circuit 20 is in the conducting state, the current directions of the movable coil 210 and the stationary coil 220 are same, the movable coil 210 approaches the stationary coil 220, and drives the movable contact 211 to be in contact with the stationary contact 222, so that the mechanical switch circuit 20 is conducted. F_{contact} in FIG. 9 indicates downward attraction force applied to the movable coil 210 and the movable contact 211.

In an embodiment, a maintenance apparatus is further disposed in the mechanical switch circuit 20. The maintenance apparatus may be configured to maintain the movable contact 211 and the stationary contact 222 in a contact state after the movable contact 211 is in contact with the stationary contact 222, and to maintain the movable contact 211 and the stationary contact 222 in a disconnected state after the movable contact 211 is disconnected from the stationary contact 222. For example, the maintenance apparatus in FIG. 9 is an electromagnet, and attraction force (F_{magnet}) generated by the electromagnet can keep the movable contact 211 and the stationary contact 222 in the contact state. It should be understood that the maintenance apparatus is merely used as an example, and the maintenance apparatus may alternatively use another implementation. In some examples, the maintenance apparatus may alternatively be implemented by using a mechanical structure such as a buckle. This is not limited in this embodiment of this application.

FIG. 10 is a schematic diagram of a cross section of a mechanical switch circuit 20 in a conducting state according to an embodiment of this application. As shown in FIG. 10, when the mechanical switch circuit 20 is in the conducting state, the current directions of the movable coil 210 and the stationary coil 220 are the opposite, the movable coil 210 stays away from the stationary coil 220, and drives the movable contact 211 to be disconnected from the stationary contact 222, so that the mechanical switch circuit 20 is conducted. Fₒₚₑₙ in FIG. 10 indicates upward repulsion force applied to the movable coil 210 and the movable contact 211.

In an embodiment, a wound coil of the movable coil 210 uses a first conductive material, a wound coil of the stationary coil 220 uses a second conductive material, and a density of the first conductive material is less than a density of the second conductive material. For example, the conductive material of the movable coil 210 may be aluminum, and the conductive material of the stationary coil 220 may be copper.

In this embodiment of this application, the wound coil of the movable coil 210 may use the conductive material with the low density, to reduce quality of the movable coil 210, and further reduce energy required when the movable coil 210 moves, to save power of the mechanical switch circuit 20.

For another example, a cross section of the movable coil 210 may be smaller than a cross section of the stationary coil 220, so that the quality of the movable coil 210 is smaller than quality of the stationary coil 220.

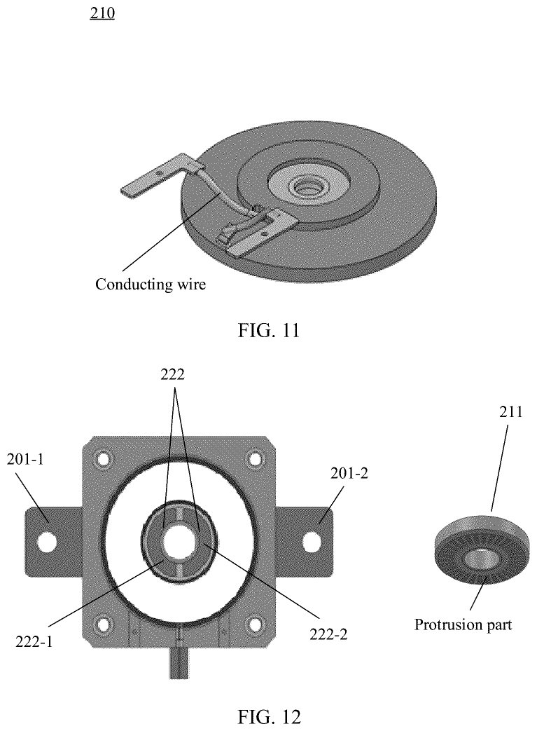

FIG. 11 is a top view of a movable coil 210 according to an embodiment of this application. As shown in FIG. 11, the wound coil of the movable coil 210 can be led out by a flexible conducting wire, so that an armature system can move automatically without damage.

FIG. 12 is a schematic diagram of structures of a movable contact 211 and a stationary contact 222 according to an embodiment of this application. The stationary contact includes the first stationary contact 222-1 and the second stationary contact 222-2. As shown in FIG. 12, the movable contact 211 is configured to ensure that when a movable contact system is closed, the stationary contacts 222 located on two sides are connected and provide the low-resistance path. When the armature system is activated, the movable coil 210 moves upward in the axial direction of the movable coil 210, thus driving the movable contact 211 to move together. It should be noted that a switching speed of the mechanical switch circuit 20 is related to a distance between the movable coil 210 and the stationary coil 220. Disconnection of the mechanical switch circuit 20 is used as an example. A longer distance between the two coils indicates longer delay time for the mechanical switch circuit 20 to start separation from the contact. Therefore, a faster separation speed of the movable contact 211 can be implemented by reducing the distance between the two coils, so that the switching speed of the mechanical switch circuit 20 can be increased, for example, a switching speed of several hundred μs (microseconds) can be implemented.

As shown in FIG. 12, in some examples, a protrusion part is disposed along a first surface of the movable contact 211, to ensure a reliable connection of the movable and stationary contacts, thereby improving switching sensitivity of the mechanical switch circuit 20. The first surface of the movable contact 211 is configured to be in contact with the stationary contact 222.

Terms such as “component”, “module”, and “system” used in this specification are used to indicate computer-related entities, hardware, firmware, combinations of hardware and software, software, or software being executed. For example, a component may be, but is not limited to, a process that runs on a processor, a processor, an object, an executable file, an execution thread, a program, and/or a computer. As shown by using figures, both a computing device and an application that runs on the computing device may be components. One or more components may reside within a process and/or an execution thread, and a component may be located on one computer and/or distributed between two or more computers. In addition, these components may be executed from various computer-readable media that store various data structures. For example, the components may communicate by using a local and/or remote process and based on, for example, a signal having one or more data packets (for example, data from two components interacting with another component in a local system, a distributed system, and/or across a network such as the internet interacting with other systems by using the signal).

A person of ordinary skill in the art may be aware that units and algorithm steps described with reference to embodiments disclosed in this specification can be implemented by electronic hardware, or a combination of computer software and electronic hardware. Whether the functions are performed by hardware or software depends on particular applications and design constraints of the technical solutions. A person skilled in the art may use different methods to implement the described functions for each particular application, but it should not be considered that the implementation goes beyond the scope of this application.

It may be clearly understood by a person skilled in the art that, for the purpose of convenient and brief description, for a detailed working process of the foregoing system, apparatus, and unit, refer to a corresponding process in the foregoing method embodiments. Details are not described herein again.

In the several embodiments provided in this application, it should be understood that the disclosed system, apparatus, and method may be implemented in other manners. For example, the described apparatus embodiment is merely an example. For example, division into the units is merely logical function division and may be other division in an actual implementation. For example, a plurality of units or components may be combined or integrated into another system, or some features may be ignored or not performed. In addition, the displayed or discussed mutual couplings or direct couplings or communication connections may be implemented through some interfaces. The indirect couplings or communication connections between the apparatuses or units may be implemented in electronic, mechanical, or other forms.

The units described as separate components may or may not be physically separate, and components displayed as units may or may not be physical units, may be located in one position, or may be distributed on a plurality of network units. Some or all of the units may be selected based on actual requirements to achieve the objectives of the solutions of embodiments.

In addition, functional units in embodiments of this application may be integrated into one processing unit, each of the units may exist alone physically, or two or more units may be integrated into one unit.

When the functions are implemented in the form of a software functional unit and sold or used as an independent product, the functions may be stored in a computer-readable storage medium. Based on such an understanding, the technical solutions of this application essentially, or the part contributing to the conventional technology, or some of the technical solutions may be implemented in a form of a software product. The computer software product is stored in a storage medium, and includes several instructions for instructing a computer device (which may be a personal computer, a server, or a network device) to perform all or some of the steps of the methods described in embodiments of this application. The storage medium includes any medium that can store program code, such as a USB flash drive, a removable hard disk, a read-only memory (ROM), a random access memory (RAM), a magnetic disk, or an optical disc.

The foregoing descriptions are merely specific implementations of this application, but are not intended to limit the protection scope of this application. Any variation or replacement readily figured out by a person skilled in the art within the technical scope disclosed in this application shall fall within the protection scope of this application. Therefore, the protection scope of this application shall be subject to the protection scope of the claims.

What is claimed is:

1. A circuit breaker, comprising a mechanical switch circuit, wherein the mechanical switch circuit comprises:
a busbar;
a power module, comprising a movable contact and a stationary contact, wherein the stationary contact is electrically connected to the busbar, the movable contact is movable, when the movable contact is in contact with the stationary contact, the mechanical switch circuit is conducted, and when the movable contact is disconnected from the stationary contact, the mechanical switch circuit is disconnected; and
a drive module, comprising a movable coil and a stationary coil, wherein the movable coil and the stationary coil are placed adjacently, so that the movable coil and the stationary coil repel or attract each other based on whether current directions are the same, and the movable coil is configured to drive the movable contact to be in contact with or disconnected from the stationary contact.

2. The circuit breaker according to claim 1, wherein the movable coil and the movable contact are a fixed connection structure, or a linkage structure is disposed between the movable coil and the movable contact.

3. The circuit breaker according to claim 1, further comprising a solid-state switch circuit, wherein the solid-state switch circuit is connected in parallel to the mechanical switch circuit, when the circuit breaker is closed, the solid-state switch circuit is conducted prior to the mechanical switch circuit, and when the circuit breaker is opened, the mechanical switch circuit is disconnected prior to the solid-state switch circuit.

4. The circuit breaker according to claim 1, wherein the movable coil is specifically configured to:
when currents flowing through the movable coil and the stationary coil are in opposite directions, stay away from the stationary coil, and drive the movable contact to be disconnected from the stationary contact; and
when the currents flowing through the movable coil and the stationary coil are in same directions, approach the stationary coil, and drive the movable contact to be in contact with the stationary contact.

5. The circuit breaker according to claim 1, wherein the busbar comprises a first busbar and a second busbar, the stationary contact comprises a first stationary contact and a second stationary contact, the first stationary contact is fastened on the first busbar, and the second stationary contact is fastened on the second busbar.

6. The circuit breaker according to claim 1, wherein a wound coil of the movable coil uses a first conductive material, a wound coil of the stationary coil uses a second conductive material, and a density of the first conductive material is less than a density of the second conductive material.

7. The circuit breaker according to claim 1, wherein the movable coil and the stationary coil are connected in series with each other.

8. The circuit breaker according to claim 1, wherein the movable coil is coaxial with the movable contact, and the movable coil can drive the movable contact to move up and down in an axial direction.

9. The circuit breaker according to claim 1, wherein a protrusion part is disposed on a first surface of the movable contact, and the first surface of the movable contact is configured to be in contact with the stationary contact.

10. The circuit breaker according to claim 1, wherein the movable coil and the movable contact are connected by using an insulation material.

11. The circuit breaker according to claim 10, wherein the movable coil is coaxial with the movable contact 211, and the movable coil 210 can drive the movable contact 211 to move up and down in an axial direction.

12. The circuit breaker according to claim 10, wherein a maintenance apparatus is further disposed in the mechanical switch circuit and the maintenance apparatus is configured to maintain the movable contact and the stationary contact in a contact state after the movable contact is in contact with the stationary contact, and to maintain the movable contact and the stationary contact in a disconnected state after the movable contact is disconnected from the stationary contact.

13. The circuit breaker according to claim 10, wherein a wound coil of the movable coil is led out by a flexible conducting wire, so that an armature system can move automatically without damage.

14. The circuit breaker according to claim 10, wherein a protrusion part is disposed along a first surface of the movable contact to ensure a reliable connection of the movable and stationary contacts.

15. A power supply system, wherein the power supply system comprises a circuit breaker, wherein the circuit breaker comprises a mechanical switch circuit, wherein the mechanical switch circuit comprises:
a busbar;
a power module, comprising a movable contact and a stationary contact, wherein the stationary contact is electrically connected to the busbar, the movable contact is movable, when the movable contact is in contact with the stationary contact, the mechanical switch circuit is conducted, and when the movable contact is disconnected from the stationary contact, the mechanical switch circuit is disconnected; and
a drive module, comprising a movable coil and a stationary coil, wherein the movable coil and the stationary coil are placed adjacently, so that the movable coil and the stationary coil repel or attract each other based on whether current directions are the same, and the movable coil is configured to drive the movable contact to be in contact with or disconnected from the stationary contact.

16. The system according to claim 15, wherein the movable coil and the movable contact are a fixed connection structure, or a linkage structure is disposed between the movable coil and the movable contact.

17. The system according to claim 15, further comprising a solid-state switch circuit, wherein the solid-state switch circuit is connected in parallel to the mechanical switch circuit, when the circuit breaker is closed, the solid-state switch circuit is conducted prior to the mechanical switch circuit, and when the circuit breaker is opened, the mechanical switch circuit is disconnected prior to the solid-state switch circuit.

18. The system according to claim 15, wherein the movable coil is specifically configured to:
when currents flowing through the movable coil and the stationary coil are in opposite directions, stay away from the stationary coil, and drive the movable contact to be disconnected from the stationary contact; and
when the currents flowing through the movable coil and the stationary coil are in same directions, approach the stationary coil, and drive the movable contact to be in contact with the stationary contact.

19. The system according to claim 15, wherein the busbar comprises a first busbar and a second busbar, the stationary contact comprises a first stationary contact and a second stationary contact, the first stationary contact is fastened on the first busbar, and the second stationary contact is fastened on the second busbar.

20. The system according to claim 15, wherein a wound coil of the movable coil uses a first conductive material, a wound coil of the stationary coil uses a second conductive material, and a density of the first conductive material is less than a density of the second conductive material.
